(19) United States
(12) Patent Application Publication
(10) Pub. No.: US 2009/0203544 A1
(43) Pub. Date: Aug. 13, 2009

(54) METHOD AND USE OF A PRINTER DEVICE FOR PRODUCING BIOLOGICAL TEST ARRAYS

(75) Inventors: Anke Pierik, Eindhoven (NL); Johan Frederik Dijksman, Eindhoven (NL); Hendrik Roelof Stapert, Eindhoven (NL); Roy Gerardus Franciscus Antonius Verbeek, Eindhoven (NL); Aleksey Kolesnychenko, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/306,289

(22) PCT Filed: Jul. 3, 2007
(86) PCT No.: PCT/IB2007/052591

§ 371 Date: Dec. 23, 2008

(30) Foreign Application Priority Data
Jul. 5, 2006 (EP) 06116646.8

(51) Int. Cl. C40B 60/14; C40B 50/14; C40B 40/00

(52) U.S. Cl. 506/13; 506/40; 506/30

(57) ABSTRACT

The invention relates to a printer device for producing biological test arrays by depositing an array of biofluids onto a substrate. The invention further relates to the use of such a device in the production of biological test arrays. The invention also relates to a method for producing a biological test array. The invention moreover relates to a biological test array. The method according to the invention is failure-proof, and results in biological test arrays of superior quality.

The invention relates to a printer device for producing biological test arrays by depositing an array of biofluids onto a substrate. The invention further relates to the use of such a device in the production of biological test arrays. The invention also relates to a method for producing a biological test array. The invention moreover relates to a biological test array.

Arrays of biofluids on a substrate are used in biological test assays, for instance for the analysis of human blood or tissue samples for the presence of certain bacteria, viruses or fungi. The arrays consist of spots with a selective binding capacity for a predetermined indicative factor, such as a protein, DNA or RNA sequence that belongs to a specific bacterium, virus or fungus. By having spots with different specificity for different factors, the array may be used to assay for various different factors at the same time. The presence of an indicative factor may be visualized for instance by fluorescent labeling of the tested sample, which results in a detectable fluorescence on the spot the specific factor adheres to. Using such arrays enables high-throughput screening of samples for a large amount of factors indicative of certain bacteria, viruses and/or fungi in a single run.

The spots are printed onto a substrate such as a membrane, by applying biofluids that contain the specific indicative factor. A suitable biofluid may for instance be a solution of a specific DNA sequence or antibody. The printing is usually done by a printing device especially designed for depositing biofluids on a substrate, usually by a different print head for each different biofluid to be included in the array. Such print heads are however prone to failure resulting in unreliable tests, for instance by missing spots in the array on substrate, or in spots that do not contain the predetermined amount of biofluid. Missing spots can not be detected, resulting in a negative result even in case the factor to be determined by the missing spot is actually present in a sample. Spots with a lacking amount of biofluid may result in a lower detected level for that spot, which could lead to false results indicating a lower level of the specific factor in the tested sample than the actual level, or in a negative result in case the detected level drops under a predetermined threshold level, referred to as a false negative result.

It is an object of the invention to provide more reliable biological test arrays.

The invention provides a printer device for producing biological test arrays by depositing an array of biofluids onto a substrate, the device comprising at least one print head provided with at least one primary nozzle for depositing a droplet of a biofluid onto the substrate, positioning means for positioning the print head relative to the substrate, detection means for detecting defects in the depositing by the primary nozzle, and control means connected to the detection means and the positioning means, wherein for each primary nozzle dedicated to a specific biofluid the printer device comprises at least one secondary nozzle dedicated to the same specific biofluid, and wherein the control means are programmed to use the secondary nozzle if a predetermined defect in the depositing by the first nozzle is detected by the detection means. Such a printer device is capable of producing biological test arrays with fewer defects. Also, with such a device higher production rates can be achieved, as less time is wasted in changing print heads in case of a malfunctioning nozzle, as such defects are immediately registered by the printer device and overcome by use of the secondary nozzle. Another time-saving factor is that quality control after production is less time-consuming, as the improved printer ensures that the number of misprinted biological test arrays is minimalized. The print head and the nozzles are especially adapted for depositing biofluids. The term biofluid covers fluids that contain the biological binding substances such as DNA sequences or antibodies that is used to specifically bind certain biomolecules in a sample on the substrate. A printer head may have multiple nozzles. It is advantageous to have one dedicated printer head for each specific kind of biofluid. However, it is possible to lead different biofluids to different nozzles on the same printer head. The positioning means are designed for moving and transporting one or more pint heads and/or substrates, in order to position a specific nozzle over the exact location of the substrate, in order to deposit a droplet of biofluid on exactly the desired position. Usually only either the print head or the substrate, but a system that moves both the print head and the substrate is thinkable. Detection means for detecting defects in the depositing by the primary nozzle may be based on any physical characteristics of the printing process. The control means usually involve a microprocessor connected to the detection means and the positioning means, and contains the necessary information to produce the predetermined array of biofluids on the substrate, in particular the positions of the nozzles and the substrate. The position of each nozzle and the exact location where a spot from a specific biofluid printer head is to be deposited are monitored by the control means. The secondary nozzle, or back-up nozzle, is dedicated to the same specific biofluid as one of the primary nozzles. Thus, the secondary nozzle may correct any detected failure or mistake by the primary nozzle, without having to stop the production process and replace the first nozzle.

It is preferred if the primary nozzle and at least one secondary nozzle are located on the same print head. Thus, in order to switch from the primary to the secondary nozzle only requires a small relative repositioning of the same print head with respect to the substrate. This also helps to improve the speed of the production.

In another preferred embodiment, the primary nozzle and at least one secondary nozzle are located on different print heads. Such a configuration makes it easier to maintain or replace the print head on which the primary nozzle is located while the secondary nozzle is carrying out the production process. Thus, the interruption of the production process is minimized.

It is most preferred if at least one secondary nozzle is located on the same print head as the primary nozzle and at least one secondary nozzle is located on at least one different print head. Thus both advantages mentioned above are met: switching from primary to secondary nozzle only takes a small repositioning of the print head with respect to the substrate, while it also enables the replacement or maintenance of nozzles with minimal interruption of the work flow.

Preferably the device comprises multiple print heads. Multiple print heads enable an optimal work flow. Each print head may comprise nozzles for different biofluids. However, preferably each print head is dedicated to a single biofluid. This allows for a simpler construction and easier replacement of the print head.

It is preferred if the device comprises multiple secondary nozzles. Multiple secondary nozzles allow to continue the production process even if one or more nozzles are being maintained or replaced. Thus, the down time of the device can me minimized.

In a preferred embodiment, the device comprises multiple print heads grouped together in an array, wherein the array comprises at least one nozzle for each different biofluid to be applied. In case a large number of different fluids have to be printed, groups of print heads may be arranged in multiple arrays. Each array of print heads forms an independently operable unit.

Preferably, the device comprises multiple identical arrays. Such arrays of print heads are mutually exchangeable, allowing for a flexible work method.

In a preferred embodiment the detection means comprise an optical sensor. Optical sensors are reliable and sensitive. The optical sensor is preferably adapted to quantize the amount of deposited biofluid on the substrate. Thus, the lacking amount of biofluid in a certain spot may be determined, and subsequently added to the predetermined amount by the secondary nozzle. The device may comprise multiple optical sensors dedicated to the same or to different detection methods. The optical sensor may be combined with other detection means, such as an acoustical sensor.

In another preferred embodiment, the detection means comprise an acoustical sensor. The acoustical sensor may be adapted to determine the amount of biofluid deposited by the nozzle. The acoustical sensor may be combined with other detection means, such as an optical sensor.

It is advantageous if the detection means are adapted to measuring an acoustical or optical characteristic of the nozzle, and wherein the control means are programmed to determine a defect by comparison of the measured characteristic of the nozzle with a predetermined characteristic of the nozzle. Thus, it is easily detected if a primary nozzle malfunctions, resulting in the secondary nozzle to be activated. Preferably the detection means and control means are adapted to quantize the amount of biofluid deposited by the nozzle, for instance by a predetermined relationship between the deposited amount of biofluid and the measured characteristic. In a preferred embodiment of the detection means, a backlight is located underneath an optically transparent substrate such as a membrane. When a droplet of biofluid is deposited on the substrate by a first nozzle, during a short period of time, this droplet is detectable as an optical contrast with the membrane that may be quantized by a camera. The spots detected on the substrate are compared to the predetermined pattern as programmed. If spots are missing, or spots are lacking in the amount of biofluid deposited, the second nozzle is activated to correct these errors. The detection of an error may also trigger the cleaning or the deactivation of the malfunctioning first nozzle.

It is also advantageous if the detection means are adapted to measuring an acoustical or optical characteristic of the substrate, and wherein the control means are programmed to determine a defect by comparison of the measured characteristic of the substrate with a predetermined characteristic of the substrate.

Preferably the detection means and control means are adapted to quantize the amount of biofluid deposited by the nozzle, for instance by a predetermined relationship between the deposited amount of biofluid and the measured characteristic.

In a preferred embodiment, the detection means comprise quantization means for determining the amount of biofluid deposited on a predetermined location of the substrate by the primary nozzle, wherein the control means are programmed to have the secondary nozzle deposit an additional amount of the same biofluid to yield a total deposited amount equal to a predetermined total amount of biofluid to be deposited on the substrate. Thus, the final deposited amount equals the predetermined amount of biofluid. This results in a higher quality of the final product, and less fall-out of products due to defects. The quantization means may for instance comprise optical sensors determining fluorescence, light absorption, lightscattering or other optical characteristics, depending on the type of biofluid to be quantized.

The invention also relates to the use of the device according to the invention in the production of biological test arrays comprising a substrate with a plurality of biofluids deposited thereon. Biological test arrays produced with such a machine are less likely to contain defects and are therefore more reliable. Moreover, the production with such a device is faster and more cost-effective, as the device is less prone to down time for maintenance or replacement of nozzles and/or print heads.

The invention further relates to a method for producing a biological test array by depositing a plurality of biofluids onto the substrate, using a printer device according to any of the preceding claims, comprising the process steps of positioning the print head relative to the substrate, depositing a droplet of a biofluid onto the substrate by the primary nozzle, detection of defects in the depositing by the primary nozzle, and subsequent depositing by the secondary nozzle if a defect in the deposited amount of biofluid by the first nozzle is detected.

The invention also relates to a biological test array comprising a substrate with a plurality of biofluids deposited thereon, obtainable by the method according to the invention. Biological test arrays produced with such a machine are less likely to contain defects and are therefore more reliable. The biofluids deposited on the substrate in production are not necessarily fluids anymore in the final product. Actually the biofluid spots on the substrate may for instance be solid- or gel-spots in the final product. Typically, a biological test array comprises 100-1000 spots, although larger amounts are also used. Each spot typically represents up to 1 nanoliter of biofluid to be deposited by a nozzle. The diameter of the spots is typically between 10-500 μm, preferably between 50-200 μm, and distances between spots within the array pattern are typically from 10-500 μm, preferably 75-400 μm. Ink jet technology may be applied to achieve deposition the biofluid. Porous membranes are a preferred substrate.

It is preferred if at least one nozzle dedicated to each different biofluid is present in order to apply the different spots to the substrate. More preferably, each type of biofluid has at least one dedicated print head. In a preferred embodiment of the device according to the invention, at least 2 print heads are dedicated to a single type of biofluid. The substrate may for instance be a porous membrane.

The invention moreover comprises a biological test kit comprising a biological test array according to the invention. Apart from the biological test array the kit may comprise fluorescent labels, buffer solutions and other tools for sample preparation.

The invention will now be further elucidated by the following non-limiting examples.

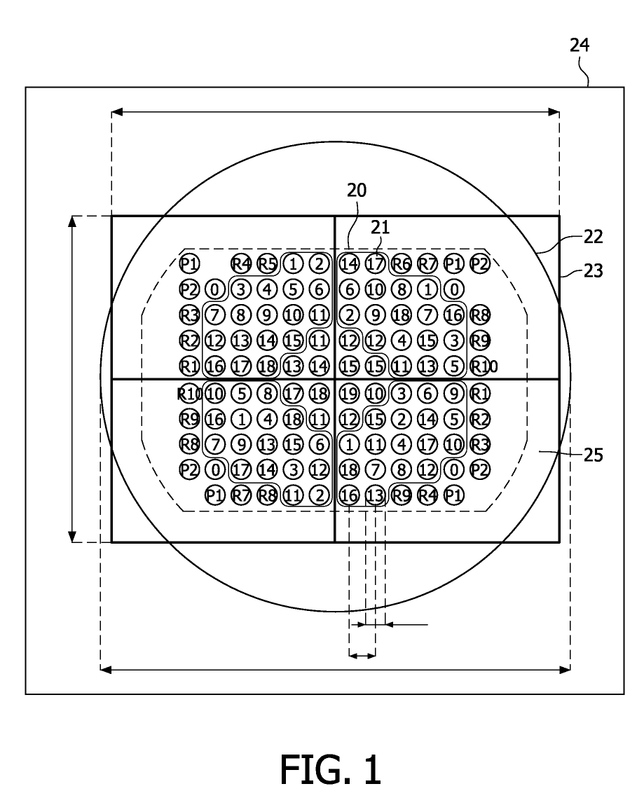

FIG. 1 shows a biological test array.

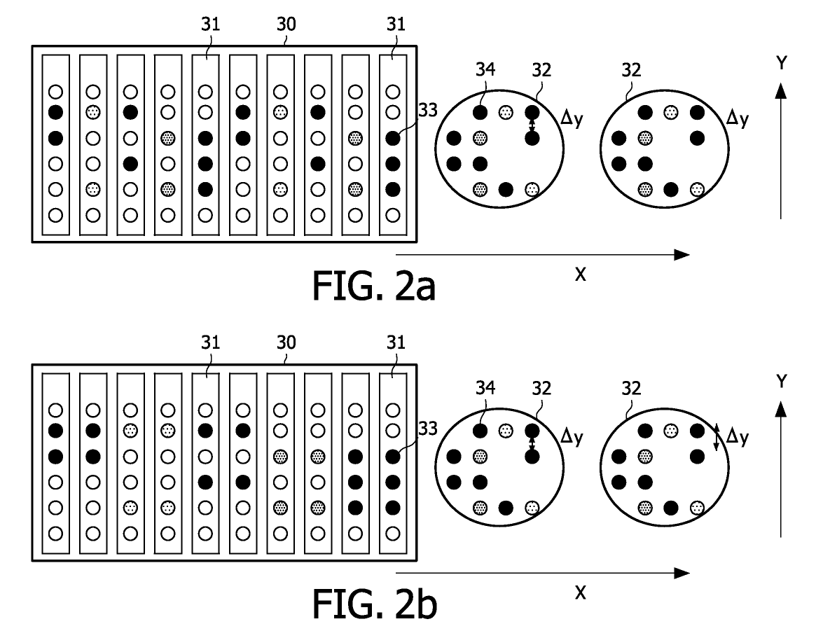

FIGS. 2a and 2b show embodiments of the method according to the invention.

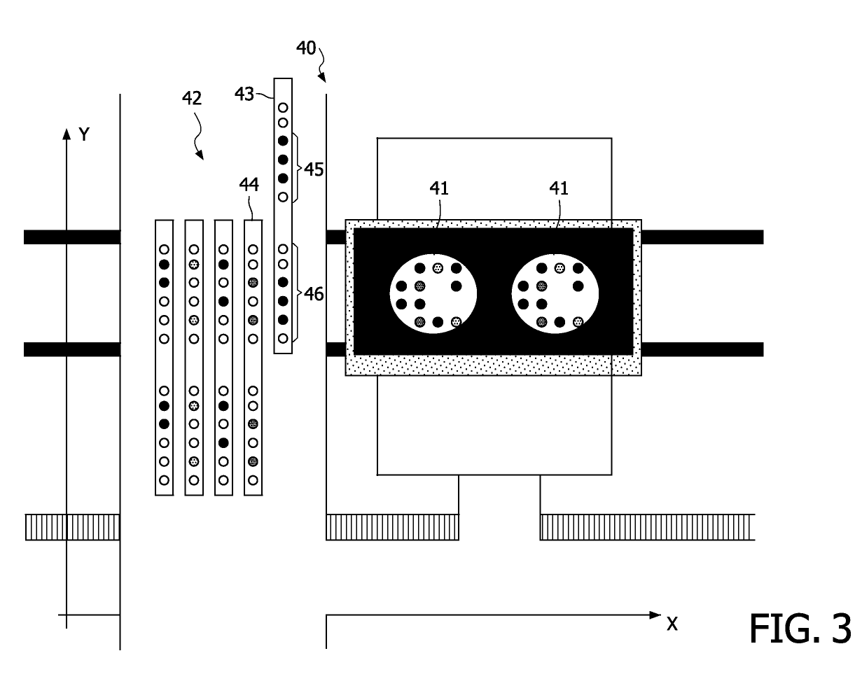

FIG. 3 shows a device according to the invention.

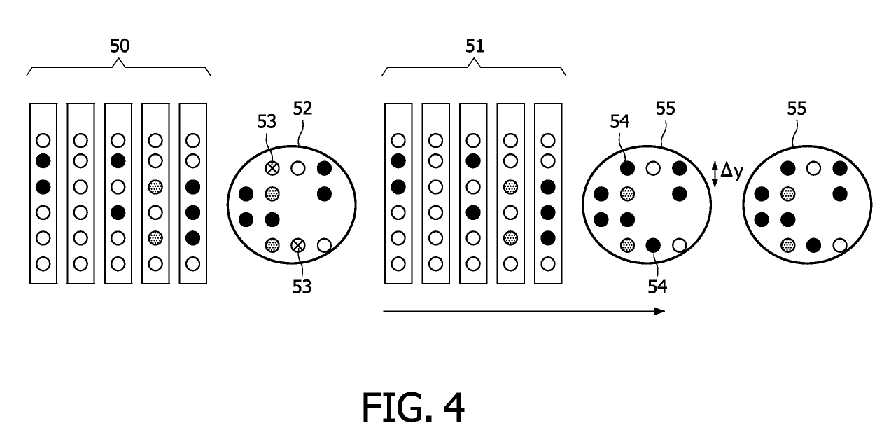

FIG. 4 shows another printer device according to the invention.

FIG. 1 shows a biological test array (20) comprising spots (21) deposited on a circular membrane (22) of about 6 mm in diameter and covered with a pattern of 128 spots (21) comprising 43 different biofluids, printed in a predefined pattern. The spots (21) are numbered, and each number represents a unique gene sequence or contains reference material. Note that the gene sequences occur in multiple duplicates in the array (20) on multiple mutually distant locations. The membrane (22) is fitted onto a supporting structure (23). As this is only an example, the number of spots may vary, and will usually much larger, depending on the number of gene sequences and the number of duplicates used. The membrane (22) with the supporting structure (holder) (23) is placed a cartridge (24). In the cartridge (24) the blood sample containing the different gene sequences characteristic for the DNA of different bacteria is brought into contact with the membrane (22) comprising the array of spots (21). Different DNA types (gene sequences) adhere to the different printed capture spots. In this Figure, different spots are visualized. The numbers 1 to 18 represent 9 different pathogens and 9 resistances. For reliability of the measurement, the same bioselective capture material is printed in four different spots. In each of these quadrants (25), spots of the same number have different neighboring spots, preventing that less intense spots (21) are not detected because of overexposure from adjacent spots (21). Intensity calibration spots are printed (R1-R10) as well as four spots (D) in the corners of the membrane for the intensity calibration distribution over the membrane (22). PCR control spots (P1, P2) are also printed to validate the proper DNA-amplification by means of PCR.

FIGS. 2a and 2b show configurations a printer head fixture plate (30) of a number of multi-nozzle print heads (31) for printing substrates (32) with different biofluids. Each biofluid may for instance contain a DNA sequence such as shown in FIG. 1. For clarity only 10 print heads (31) are shown, each 6 nozzles (33), comprising nozzles dedicated to 5 different biofluids. Nozzles for each bio fluid are present on 2 different print heads 31. However, it is not unthinkable that a single print head (31) would contain nozzles (33) dedicated to different biofluids. The membranes (32) are printed with a four by four array of dots (34). For producing a biological test array with more different types of biofluids, a corresponding larger number of print heads 31 is needed. The print direction is shown with arrow X, the dots are arranged in rows in direction Y, perpendicular to the print direction X.

A great increase in reliability of the printing process is obtained when using two print heads per fluid in parallel (unison or tandem). This idea is depicted in FIGS. 2a and 2b. In FIG. 2a the print heads (31) are grouped in such a way that first five print heads (31) are passed with five different fluids followed by a next set of similar print heads (31). FIG. 2b shows an arrangement where the print heads (31) filled with the same fluid are placed next to each other. The software controlling the print operation registers exactly where the different print heads are located in the print head fixture plate. Before starting the printing process all nozzles (33) are checked optically and acoustic fingerprints are recorded, as a reference characteristic for proper functioning. During printing continuously the actual pressure recordings are compared with the acoustic and/or optical fingerprints. At the very moment a recording of a nozzle deviates from its fingerprint by a predetermined threshold, the software controlling the overall printing operation stops that nozzle (31) and let the amount of fluid needed be deposited by the corresponding secondary nozzle (31) of the print head containing the same fluid. Thus, these arrangements of print heads and nozzles offer the possibility of repairing and maintaining the primary nozzles while the secondary nozzle takes over the tasks of the primary nozzle, thus enabling a higher production speed and reducing down time of the device. Maintenance of a nozzle (31) may for instance include purging and/or cleaning of the nozzle plate. Also, the quality of the produced array of dots is improved, resulting in less defect products (with for instance missing spots or misprinted spots) and reduction of waste.

FIG. 3 shows a printer device (40) mounted with 2 membranes (41), that are part of an elongate tray that supplies multiple substrates (41) to the assembly (42) of linear array print heads (43, 44). The action of the print heads (43, 44) is monitored optically and/or acoustically by detection means known in the art. At the very moment a nozzle (45) fails the print head (43) is moved by a mechanism in the Y direction such that a new set of nozzles (46) comes into action. The Figure shows a print head with double the amount of nozzles needed during printing, so there is one back-up nozzle (46) for each operating nozzle (45). The number of rows on the substrate and the number of nozzles of the print head may be increased in order to provide a greater flexibility and a higher level of fail-proof

FIG. 4 shows a printer device wherein a two sets of printer heads (50, 51) are arranged according to the invention. The first set of printer heads (50) has printed dots on a substrate (52). Optical detection means (not shown), detect two defects (53) with respect to the predetermined pattern that should have been printed. Subsequently, the second set of print heads (51) corrects the omitted dots (53) by applying new dots (54), resulting in substrates (55) with the correct predetermined pattern.

For a person skilled in the art, many variations and combinations of the shown non-limitative examples are directly derivable from the invention.

1. Printer device (40) for producing biological test arrays (20) by depositing an array of biofluids onto a substrate (22, 32, 52, 55), the device comprising:
at least one print head (31, 43, 44) provided with at least one primary nozzle (33, 45) for depositing a droplet of a biofluid onto the substrate (22, 32, 52, 55),
positioning means for positioning the print head (31, 43, 44) relative to the substrate (22, 32, 52, 55),
detection means for detecting defects in the depositing by the primary nozzle (33, 45), and
control means connected to the detection means and the positioning means, wherein for each primary nozzle (33, 45) dedicated to a specific biofluid the printer device (40) comprises at least one secondary nozzle (33, 46) dedicated to the same specific biofluid, and wherein the control means are programmed to use the secondary nozzle (33, 46) if a predetermined defect in the depositing by the first nozzle (33, 45) is detected by the detection means.

2. Printer device (40) according to claim 1, characterized in that the primary nozzle (33, 45) and at least one secondary nozzle (33, 46) are located on the same print head (31, 43, 44).

3. Printer device (40) according to claim 1, characterized in that the primary nozzle (33, 45) and at least one secondary nozzle (33, 46) are located on different print heads (31, 43, 44).

4. Printer device (40) according to claim 1, characterized in that at least one secondary nozzle (33, 46) is located on the same print head (31, 43, 44) as the primary nozzle (33, 45) and at least one secondary nozzle (33, 46) is located on at least one different print head (31, 43, 44).

5. Printer device (40) according to claim 1, characterized in that the printer device (40) comprises multiple print heads (31, 43, 44).

6. Printer device (40) according to claim 1, characterized in that the printer device (40) comprises multiple secondary nozzles (33, 46).

7. Printer device (40) according to claim 1, characterized in that the printer device (40) comprises multiple print heads (31, 43, 44) grouped together an array (42, 50, 51), wherein the array (42, 50, 51) comprises at least one nozzle (33, 45, 46) for each different biofluid to be applied.

8. Printer device (40) according to claim 8, characterized in that the printer device (40) comprises multiple identical arrays (42, 50, 51).

9. Printer device (40) according to claim 1, characterized in that the detection means comprise an optical sensor.

10. Printer device (40) according to claim 1, characterized in that the detection means comprise an acoustical sensor.

11. Printer device (40) according to claim 1, characterized in that the detection means are adapted to measuring an acoustical or optical characteristic of the nozzle (33, 45, 46), and wherein the control means are programmed to determine a defect (53) by comparison of the measured characteristic of the nozzle (33, 45, 46) with a predetermined characteristic of the nozzle (33, 45, 46).

12. Printer device (40) according to claim 1, characterized in that the detection means are adapted to measuring an acoustical or optical characteristic of the substrate (22, 32, 52, 55), and wherein the control means are programmed to determine a defect (53) by comparison of the measured characteristic of the substrate (22, 32, 52, 55) with a predetermined characteristic of the substrate (22, 32, 52, 55).

13. Printer device (40) according to claim 1, characterized in that the detection means comprise quantization means for determining the amount of biofluid (53,54) deposited on a predetermined location of the substrate (22, 32, 52, 55)) by the primary nozzle, wherein the control means are programmed to have the secondary nozzle (33, 46) deposit an additional amount of the same biofluid to yield a total deposited amount equal to a predetermined total amount of biofluid to be deposited on the substrate (22, 32, 52, 55).

14. Use of the printer device (40) according to claim 1, in the production of biological test arrays comprising a substrate (22, 32) with a plurality of biofluids deposited thereon.

15. Method for producing a biological test array by depositing a plurality of biofluids onto the substrate (22, 32), using a printer device (40) according to claim 1, comprising the process steps of
positioning the print head (31, 43, 44) relative to the substrate (22, 32, 52, 55),
depositing a droplet of a biofluid onto the substrate (22, 32, 52, 55) by the primary nozzle (33, 45),
detection of defects in the depositing by the primary nozzle (33, 45), and subsequent depositing by the secondary nozzle (33, 46) if a defect in the deposited amount of biofluid by the first nozzle (33, 45) is detected.

16. Biological test array comprising a substrate (22, 32, 52, 55) with a plurality of biofluids deposited thereon, obtainable by the method according to claim 15.

17. Biological test kit comprising a biological test array according to claim 16.
